(19) United States
(12) Patent Application Publication
(10) Pub. No.: US 2025/0282212 A1
(43) Pub. Date: Sep. 11, 2025

(54) THERMAL MANAGEMENT SYSTEM

(71) Applicant: TOYOTA JIDOSHA KABUSHIKI KAISHA, Toyota-shi (JP)

(72) Inventors: Yoichi OGURA, Sunto-gun (JP); Hiroyuki Sugihara, Sunto-gun (JP); Ryo Nakabayashi, Susono-shi (JP); Ryo Michikawauchi, Numazu-shi (JP); Kunihiko Hayashi, Odawara-shi (JP)

(73) Assignee: TOYOTA JIDOSHA KABUSHIKI KAISHA, Toyota-shi (JP)

(21) Appl. No.: 18/980,250

(22) Filed: Dec. 13, 2024

(30) Foreign Application Priority Data
Mar. 11, 2024 (JP) 2024-037223

(51) Int. Cl. B60K 11/04

(52) U.S. Cl. CPC B60K 11/04

(57) ABSTRACT

The thermal management system includes an HT radiator (first radiator), an LT radiator (second radiator), a nine-way valve (switching device) and a five-way valve (switching device) for switching a flow path of the heat medium, and an ECU (control device). ECU controls the nine-way valve and the five-way valve to switch between a first heat medium circuit in which HT radiator and LT radiator are separated from each other and a second heat medium circuit including a series circuit in which HT radiator and LT radiator are connected in series.

### CROSS-REFERENCE TO RELATED APPLICATION

This application claims priority to Japanese Patent Application No. 2024-037223 filed on Mar. 11, 2024, incorporated herein by reference in its entirety.

### BACKGROUND

### 1. Technical Field

The present disclosure relates to a thermal management system.

### 2. Description of Related Art

Japanese Unexamined Patent Application Publication No. 2020-185829 (JP 2020-185829 A) discloses an electrified vehicle that includes an in-vehicle temperature control device including a high-temperature radiator and a low-temperature radiator. The high-temperature radiator is provided in a high-temperature circuit. The low-temperature radiator is provided in a low-temperature circuit. The high temperature circuit and the low temperature circuit are independent of each other.

### SUMMARY

In JP 2020-185829 A, as described above, the high-temperature circuit and the low-temperature circuit are independent of each other. That is, the high-temperature radiator and the low-temperature radiator are provided to cool different heat sources. Therefore, there is a possibility that the cooling power is insufficient with only one radiator when the amount of heat of a heat source is large.

The present disclosure has been made to address the above issue, and has an object to provide a thermal management system capable of efficiently cooling a heat source using two radiators.

An aspect of the present disclosure provides a thermal management system in which a heat medium circulates, and the thermal management system includes: a first radiator;
a second radiator that is different from the first radiator;
a switching device that switches a flow path of the heat medium; and
a control device that controls the switching device.

The control device controls the switching device so as to switch between
a first heat medium circuit in which the first radiator and the second radiator are separated to be independent of each other, and
a second heat medium circuit that includes a series circuit in which the first radiator and the second radiator are connected in series with each other.

In the thermal management system according to the aspect of the present disclosure, as described above, a second heat medium circuit that includes a series circuit in which the first radiator and the second radiator are connected in series with each other is formed. Thus, a common heat source can be cooled by both the first radiator and the second radiator. As a result, a heat source can be efficiently cooled by forming the second heat medium circuit when the amount of heat generated by the heat source is relatively large or the like. When the amount of heat generated by a heat source is relatively small, meanwhile, the cooling by the first radiator and the cooling by the second radiator can be individually performed by forming the first heat medium circuit. As a result, a heat source can be efficiently cooled when the amount of heat generated by the heat source is relatively small or the like.

The thermal management system may further include:
a power storage device; and
a drive device capable of generating a drive force.

In the first heat medium circuit,
the first radiator may discharge heat supplied from the power storage device to outside air, and
the heat medium flowing through the second radiator may perform heat exchange with the drive device.

In the second heat medium circuit, each of the first radiator and the second radiator may discharge the heat supplied from the power storage device to the outside air.

With such a configuration, the first radiator provided for the power storage device and the second radiator provided for the drive device in the first heat medium circuit can be used in combination to cool the power storage device in the second heat medium circuit. Thus, the power storage device can be efficiently cooled by the first radiator and the second radiator in the second heat medium circuit.

The control device may form the second heat medium circuit by controlling the switching device when the power storage device is externally charged. With such a configuration, the power storage device can be efficiently cooled using both the first radiator and the second radiator during external charging in which the temperature of the power storage device is relatively likely to increase.

The control device may form the second heat medium circuit by controlling the switching device when the power storage device is externally charged through rapid charging. With such a configuration, the power storage device can be efficiently cooled using both the first radiator and the second radiator during external charging in which the temperature of the power storage device is more likely to increase than during normal charging.

The switching device may include a nine-way valve and a five-way valve. The control device may switch between the first heat medium circuit and the second heat medium circuit by controlling each of the nine-way valve and the five-way valve. With such a configuration, it is possible to easily switch between the first heat medium circuit and the second heat medium circuit by switching the flow path of the heat medium using two different multi-way valves (nine-way valve and five-way valve).

According to the present disclosure, it is possible to efficiently cool a heat source using two different radiators.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a vehicle equipped with a thermal management system according to an embodiment;

FIG. 2 is a diagram illustrating a configuration of a thermal management circuit of a thermal management system according to an embodiment;

FIG. 3 is a diagram illustrating a first heat medium circuit of a heat management circuit according to an embodiment;

FIG. 4 is a diagram illustrating a second heat medium circuit of a heat management circuit according to an embodiment;

FIG. 5 is a diagram illustrating a third heat medium circuit of a heat managing circuit according to an embodiment; and

FIG. 6 is a diagram illustrating a control flowchart of a ECU according to an embodiment.

### DETAILED DESCRIPTION OF EMBODIMENTS

Hereinafter, an embodiment of the present disclosure will be described in detail with reference to the drawings. The same or corresponding parts in the drawings are designated by the same reference characters and repetitive description will be omitted.

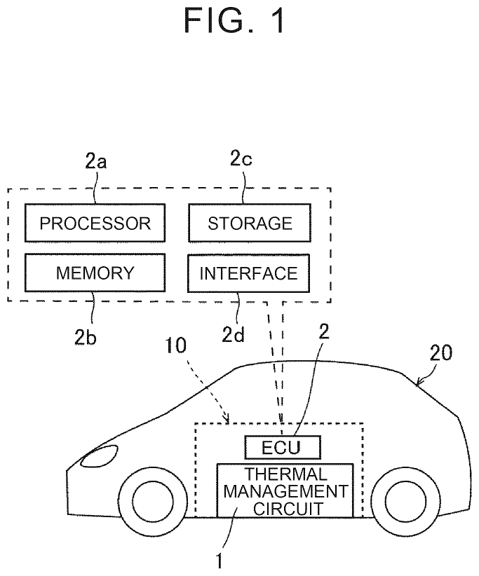

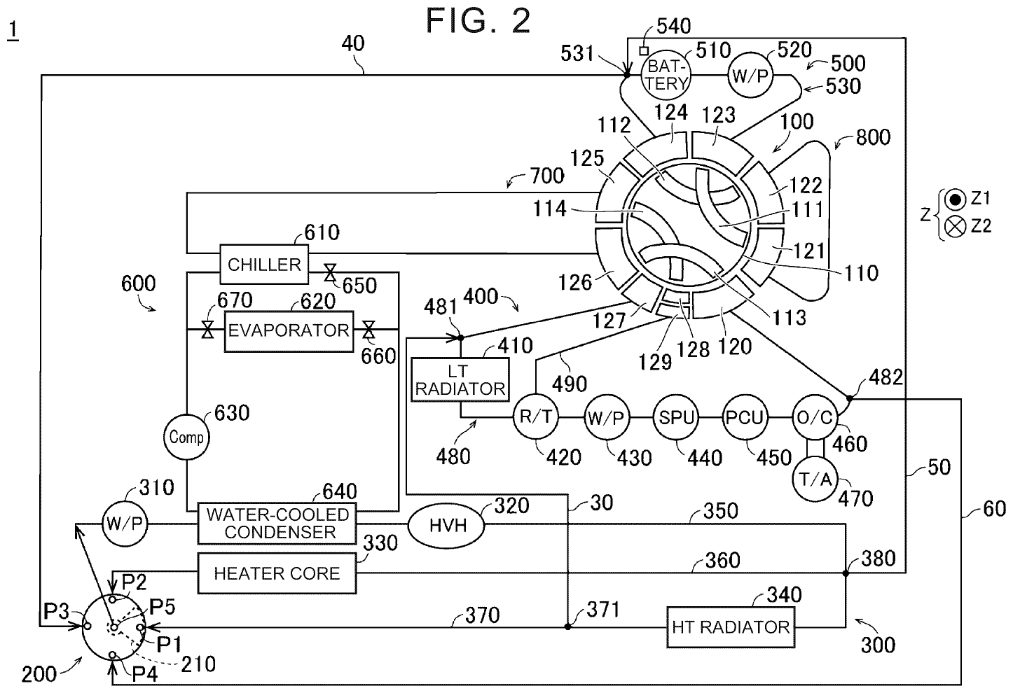

As illustrated in FIG. 1, a configuration in which the thermal management system 10 according to the present disclosure is mounted on a electrified vehicle 20 will be described below. Electrified vehicle 20 is preferably a vehicle equipped with a battery 510 (described below, FIG. 2) for traveling. Electrified vehicle 20 is, for example, battery electric vehicle (BEV: Battery Electric Vehicle). Alternatively, electrified vehicle 20 is, for example, hybrid electric vehicle (HEV: Hybrid Electric Vehicle), plug-in hybrid electric vehicle (PHEV: Plug-in Hybrid Electric Vehicle), or fuel cell electric vehicle (FCEV: Fuel Cell Electric Vehicle). However, the use of the thermal management system according to the present disclosure is not limited to a vehicle.

The thermal management system 10 includes a thermal management circuit 1 and an ECU (Electronic Control Unit) 2. Note that ECU 2 is an exemplary “control device” of the present disclosure.

ECU 2 includes a processor 2a, a memory 2b, a storage 2c, and an interface 2d.

The processor 2a is, for example, CPU (Central Processing Unit) or MPU (Micro-Processing Unit). The memory 2b is, for example, RAM (Random Access Memory). The storage 2c is a rewritable non-volatile memory such as HDD (Hard Disk Drive), SSD (Solid State Drive), and flash memory. The storage 2c stores a system program including OS (Operating System) and a control program including computer-readable code required for control operations. The processor 2a realizes various processes by reading out a system program and a control program, expanding the program into a memory 2b, and executing the program. The interface 2d controls the communication between ECU 2 and the components of the thermal management circuit 1.

ECU 2 generates a control command based on a sensor value acquired from various sensors included in the thermal management circuit 1, a user manipulation received by an HMI (Human Machine Interface) (not shown) provided in electrified vehicle 20, and the like. ECU 2 outputs the generated control command to the thermal management circuit 1. ECU 2 may be divided into a plurality of ECU for each function. Further, although FIG. 1 shows an exemplary ECU 2 including one processor 2a, ECU 2 may include a plurality of processors. The same applies to the memory 2b and the storage 2c.

### Configuration of Thermal Management Circuit

FIG. 2 is a diagram illustrating an example of a configuration of the thermal management circuit 1 according to the present embodiment. The thermal management circuit 1 includes a nine-way valve 100, a five-way valve 200, a high-temperature circuit 300, a unit circuit 400, a battery circuit 500, a refrigeration cycle 600, a flow path 700, and a flow path 800. The thermal management circuit 1 includes a flow path 30, a flow path 40, a flow path 50, and a flow path 60. Note that each of the nine-way valve 100 and the five-way valve 200 is an example of a “switching device” of the present disclosure.

The nine-way valve 100 includes a valve body 110 and outer sections 120 to 129. The valve body 110 has a cylindrical shape extending in the Z direction, and is configured to be rotatable about a central axis line (not shown) of the valve body 110. The valve body 110 is surrounded by the outer sections 120 to 129 when viewed from Z1. The valve body 110 rotates in accordance with a control command from ECU 2 (FIG. 1).

The valve body 110 is provided with an internal flow path 111, an internal flow path 112, an internal flow path 113, and an internal flow path 114. When the valve body 110 rotates in accordance with a control command from ECU 2, the positions of the internal flow paths 111 to 114 are changed. As a result, the connection (connection combination) between the outer sections 120 to 129 and the internal flow paths 111 to 114 is changed. Details will be described later.

The internal flow path 111 is disposed Z1 the internal flow path 112. The internal flow path 113 is disposed Z1 the internal flow path 114. The internal flow path 111 and the internal flow path 113 are arranged at the same position in the Z direction. The internal flow path 112 and the internal flow path 114 are arranged at the same position in the Z direction.

The outer sections 120 to 129 are circumferentially arranged on the outer peripheral side of the valve body 110. The outer sections 120 to 129 are isolated from each other. Although the outer sections 128 and 129 are shown as being arranged side by side in FIG. 2 for clarity, they are actually stacked in the Z direction. The outer section 129 is disposed Z2 the outer section 128.

Each of the outer sections 120 to 126 has substantially the same width in the circumferential direction of the valve body 110. The circumferential width of each of the outer sections 127 to 129 is less than the circumferential width of the outer sections 120 to 126.

The five-way valve 200 has a cylindrical shape extending in the Z direction. The five-way valve 200 has ports P1 to P5. P4 from the port P1 is an inlet port that allows the heating medium to flow into the five-way valve 200. The port P5 is an outlet port that allows the heating medium to flow out of the five-way valve 200. P4 from the port P1 is in communication with a lower compartment (not shown) that is isolated from one another. That is, the five-way valve 200 is provided with four lower compartments that are isolated from each other. Although not shown, the four sections have the same shape (a sector shape having a central angle of 90 degrees when viewed from Z1 side). The port P5 communicates with an upper compartment (not shown) provided Z1 of the four lower compartments.

The flow condition of the heat medium from the ports P1 to P5 is controlled by a control command from ECU 2 (FIG. 1). Specifically, ECU 2 changes the position of the opening 210. Inside the five-way valve 200, a partition plate (not shown) for partitioning the four lower and upper partitions is provided, the opening 210 is formed in the partition plate. The partition plate is rotationally moved about the central axial line of the five-way valve 200 having a cylindrical shape by a control command from ECU 2. As a result, the lower section overlapping with the opening 210 in the Z direction changes. The port P5 is only in communication with a port that communicates with the lower compartment that overlaps the opening 210 in the Z-direction.

The opening 210 has a sector shape with a central angle of about 90 degrees when viewed from Z1. Thus, one or two of the four lower compartments may simultaneously overlap the opening 210 in the Z direction. This causes one or two ports of the ports P1 to P4 to communicate with the port P5.

The high-temperature circuit 300 includes a water pump 310, an HVH (High Voltage Heater) 320, a heater core 330, and an HT (High Temperature) radiator 340. The water pump 310 circulates the heating medium in the high-temperature circuit 300 in accordance with a control command from ECU 2 (FIG. 1). Note that HT radiator 340 is an exemplary “first radiator” of the present disclosure.

The high-temperature circuit 300 includes a flow path 350, a flow path 360, and a flow path 370. The flow path 350 connects the port P5 and the branch point 380. The flow path 350 is provided with a water pump 310 and an HVH 320. The flow path of the flow path 350 between the water pump 310 and HVH 320 is also connected to a water-cooled condenser 640 of the refrigeration cycle 600, which will be described later. That is, in the water-cooled condenser 640, heat exchange is performed between the heat medium circulating in the refrigeration cycle 600 and the heat medium flowing through the flow path 350.

The flow path 360 connects the branch point 380 and the port P2. The flow path 360 is provided with a heater core 330.

The flow path 370 connects the branch point 380 and the port P1. A HT radiator 340 is provided in the flow path 370.

unit circuit 400 includes an LT (Low Temperature) radiator 410, a reserve tank 420, and a water pump 430, unit circuit 400 also includes SPU (Smart Power Unit) 440, PCU (Power Control Unit) 450, oil cooler (O/C) 460, and transaxle (T/A) 470. The water pump 430 circulates the heating medium in accordance with a control command from ECU 2 (FIG. 1). The water pump 430 delivers a heat medium to SPU 413. The transaxle 470 is capable of generating the driving force of electrified vehicle 20 (FIG. 1). Note that LT radiator 410 is an exemplary “second radiator” of the present disclosure. In addition, each of PCU 450 and the transaxle 470 is an exemplary “drive device” of the present disclosure.

The unit circuit 400 includes a flow path 480 and a flow path 490. The flow path 480 connects the outer section 127 and the outer section 120 of the nine-way valve 100. The flow path 480 is provided with a LT radiator 410, a reserve tank 420, a water pump 430, an SPU 440, PCU 450, and an oil cooler 460. Each of SPU 440 and PCU 450 includes a heat exchanger (not shown) that exchanges heat with a heat medium of the flow path 480. The oil cooler 460 exchanges heat between the transaxle 470 and the heat medium in the flow path 480. Instead of the oil cooler 460, a transaxle 470 may be provided in the flow path 480.

The flow path 490 connects the outer section 129 of the nine-way valve 100 and the reserve tank 420.

The battery circuit 500 includes a battery 510, a water pump 520, a flow path 530, and a temperature sensor 540. The water pump 520 delivers a heat medium to the battery 510 side. The water pump 520 circulates the heat medium in accordance with a control command from ECU 2 (FIG. 1). Note that the battery 510 is an example of a “power storage device” of the present disclosure.

The flow path 530 connects the outer section 123 and the outer section 124 of the nine-way valve 100. The flow path 530 is provided with a battery 510 and a water pump 520. The battery 510 includes a heat exchanger (not shown) that exchanges heat with the heat medium of the flow path 530.

The temperature sensor 540 detects the temperature of the battery 510. The data detected by the temperature sensor 540 is transmitted to ECU 2 (FIG. 1).

The refrigeration cycle 600 includes a chiller 610, an evaporator 620, a compressor 630, and a water-cooled condenser 640. The refrigeration cycle 600 includes an expansion valve 650, an expansion valve 660, and an EPR (Evaporative Pressure Regulator) 670. A heat medium (a gas-phase refrigerant or a liquid-phase refrigerant) circulating in the refrigeration cycle 600 flows through one/both of the first path and the second path. The first path is the path of compressor 630, water cooled condenser 640, expansion valve 660, evaporator 620, EPR 670, and compressor 630. The second path is the path of compressor 630, water cooled condenser 640, expansion valve 650, chiller 610, and compressor 630.

The flow path 700 connects the outer section 125 and the outer section 126 of the nine-way valve 100. The flow path 700 is also connected to the chiller 610 of the refrigeration cycle 600. That is, the heat medium flowing through the flow path 700 and the heat medium of the refrigeration cycle 600 are heat-exchanged in the chiller 610.

The flow path 800 connects the outer section 121 and the outer section 122 of the nine-way valve 100. A device or the like is not provided in the flow path 800.

The flow path 30 connects the branch point 371 and the merging portion 481. The branch point 371 is provided between HT radiator 340 and the five-way valve 200 in the flow path 370 of the high-temperature circuit 300. The merging portion 481 is provided between LT radiator 410 and the nine-way valve 100 in the flow path 480 of the unit circuit 400. That is, the heat medium of the flow path 370 branched into the flow path 30 at the branch point 371 is merged into the heat medium of the flow path 480 at the merging portion 481.

The flow path 40 connects the port P3 of the nine-way valve 100 and a branch point 531 of the flow path 530 of the battery circuit 500 provided between the battery 510 and the outer section 124. That is, the heat medium in the flow path 530 branched into the flow path 40 at the branch point 531 flows into the five-way valve 200 from the port P3.

The flow path 50 connects the branch point 380 of the high-temperature circuit 300 and the branch point 531 of the battery circuit 500. That is, the heat medium of the high-temperature circuit 300 (the flow path 350) branched into the flow path 50 at the branch point 380 merges into the flow path 530 at the branch point 531.

The flow path 60 connects the port P4 of the five-way valve 200 and the branch point 482 of the flow path 480 of the unit circuit 400 between the oil cooler 460 and the outer section 120 of the nine-way valve 100. That is, the heat medium in the flow path 480 branched into the flow path 60 at the branch point 482 flows into the five-way valve 200 from the port P4.

Here, in the conventional thermal management system, HT radiator and LT radiator cool heat sources differently from each other. Therefore, when the amount of heat of the heat source is large, the cooling power may be insufficient by only one of the radiators.

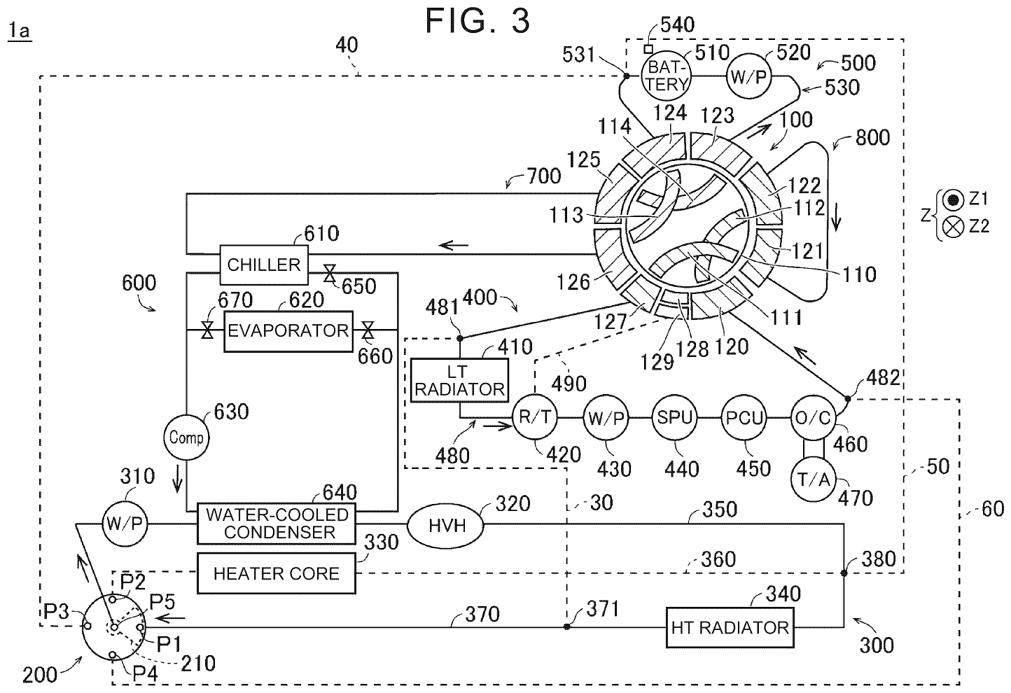

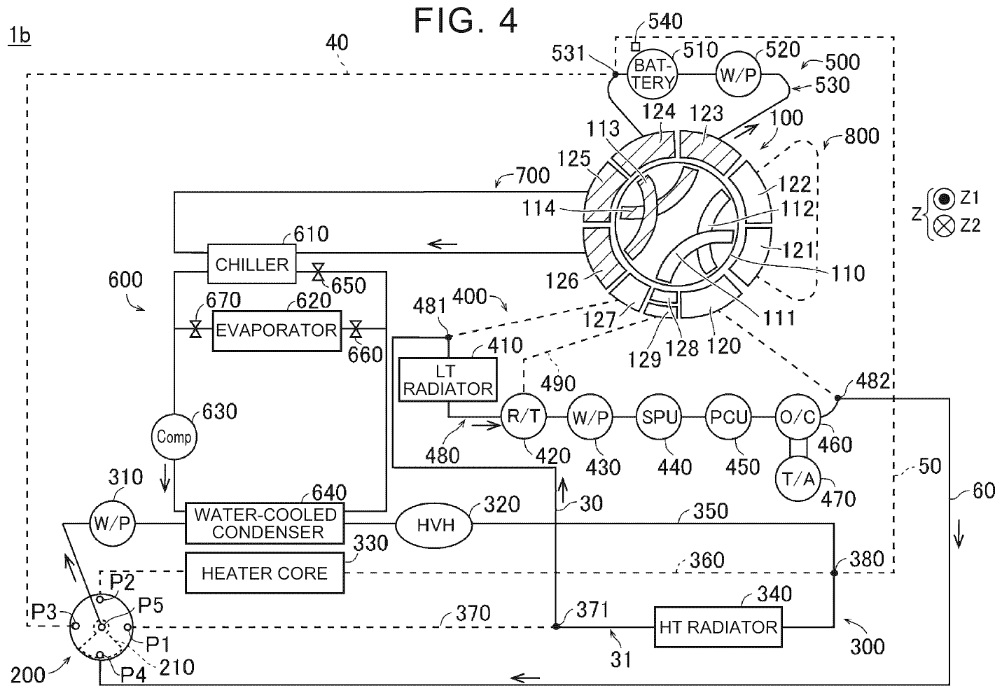

Therefore, in the present embodiment, ECU 2 controls the nine-way valve 100 and the five-way valve 200 to switch between the first heat medium circuit 1a (FIG. 3) and the second heat medium circuit 1b (FIG. 4). In the first heat medium circuit 1a (FIG. 3), HT radiator 340 and LT radiator 410 are separated from each other and are independent of each other. The second heat medium circuit 1b (FIG. 4) includes a series circuit 31 in which HT radiator 340 and LT radiator 410 are connected in series. Each of the first heat medium circuit 1a and the second heat medium circuit 1b is a circuit for cooling the battery 510.

First heat Medium Circuit

FIG. 3 is a diagram illustrating a first heat medium circuit 1a of the thermal management circuit 1. In the first heat medium circuit 1a, HT radiator 340 and LT radiator 410 are provided in separate circulation circuits. Discuss in detail below

The internal flow path 111 of the nine-way valve 100 connects the outer section 121 and the outer section 127. The internal flow path 112 connects the outer section 120 and the outer section 122. The internal flow path 113 connects the outer section 124 and the outer section 126. The internal flow path 114 connects the outer section 123 and the outer section 125.

In the five-way valve 200, the opening 210 overlaps only the lower compartment that communicates with the port P1. Thus, the port P5 is in communication with only the port P1 of the ports P1 to P4.

As a result, the heat medium circulates through the circuit of the five-way valve 200 (port P5), the water pump 310, the water-cooled condenser 640, HVH 320, HT radiator 340, and the five-way valve 200 (port P1) (the circulation circuit in the high-temperature circuit 300).

The heating medium also circulates in the circuitry of the reserve tank 420, water pump 430, SPU 440, PCU 450, oil cooler 460, outer compartment 120, inner channel 112, outer compartment 122, channel 800, outer compartment 121, inner channel 111, outer compartment 127, LT radiator 410, and reserve tank 420. In the first heat medium circuit 1a, the heat medium flowing through LT radiator 410 exchanges heat with SPU 440, PCU 450 and the transaxle 470 (oil cooler 460).

In addition, the heat medium circulates in the circuits of the water pump 520, the battery 510, the outer section 124, the internal flow path 113, the outer section 126, the chiller 610, the outer section 125, the internal flow path 114, the outer section 123, and the water pump 520.

In addition, in the refrigeration cycle 600, the heat medium circulates through the circuit of the chiller 610, compressor 630, water-cooled condenser 640, expansion valve 650, and chiller 610.

In the first heat medium circuit 1a, HT radiator 340 discharges heat (heat generated in the battery 510) supplied from the battery 510 to the outside air. The heat of the battery 510 is transferred to the high-temperature circuit 300 through the chiller 610 (refrigeration cycle 600) and the water-cooled condenser 640, and is discharged from HT radiator 340 to the outside air.

In the first heat medium circuit 1a, the heat medium does not flow through each of the flow path 30, the flow path 40, the flow path 50, and the flow path 60. In the first heat medium circuit 1a, the heat medium does not flow through the flow path 490.

### Second Heat Medium Circuit

FIG. 4 is a diagram illustrating a second heat medium circuit 1b of the thermal management circuit 1. In the second heat medium circuit 1b, HT radiator 340 and

LT radiator 410 are provided in a common circulation circuit.

The internal flow path 111 of the nine-way valve 100 connects the outer section 121 and the outer section 128. The internal flow path 112 connects the outer section 120 and the outer section 122. The internal flow path 113 connects the outer section 124 and the outer section 126. The internal flow path 114 connects the outer section 123 and the outer section 125.

In the five-way valve 200, the opening 210 overlaps only the lower compartment that communicates with the port P4. Thus, the port P5 is in communication with only the port P4 of the ports P1 to P4.

As a result, the heating medium circulates through the circuitry of the five-way valve 200 (port P5), the water pump 310, the water-cooled condenser 640, HVH 320, HT radiator 340, the branch point 371, the flow path 30, the merging portion 481, LT radiator 410, the reserve tank 420, the water pump 430, SPU 440, PCU 450, oil cooler 460, the branch point 482, the flow path 60, and the five-way valve 200 (port P4). A series circuit 31 in which HT radiator 340 and LT radiator 410 are connected in series is formed in the circulation circuit.

In addition, the heat medium circulates in the circuits of the water pump 520, the battery 510, the outer section 124, the internal flow path 113, the outer section 126, the chiller 610, the outer section 125, the internal flow path 114, the outer section 123, and the water pump 520.

In addition, in the refrigeration cycle 600, the heat medium circulates through the circuit of the chiller 610, compressor 630, water-cooled condenser 640, expansion valve 650, and -chiller 610.

The heat of the battery 510 is transmitted to the high-temperature circuit 300 through the chiller 610 (refrigeration cycle 600) and the water-cooled condenser 640, and is transmitted to the unit circuit 400 through the flow path 30. Thus, in the second heat medium circuit 1b, each of HT radiator 340 and LT radiator 410 discharges the heat (the heat generated in the battery 510) supplied from the battery 510 to the outside air.

In the second heat medium circuit 1b, the heat medium does not flow through each of the flow path 50 and the flow path 60. In the second heat medium circuit 1b, the heat medium does not flow through the flow path 490.

### Third Heat Medium Circuit

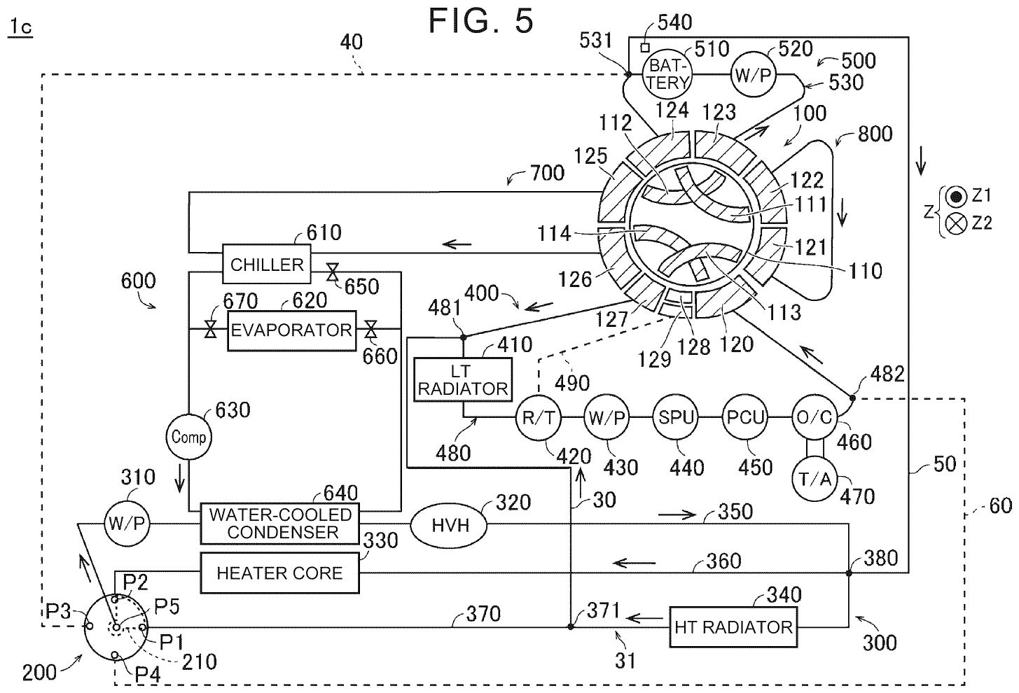

FIG. 5 is a diagram illustrating a third heat medium circuit 1c of the thermal management circuit 1. The third heat medium circuit 1c is a circuit for passing water to the respective devices of the thermal management circuit 1. Thus, it is possible to eliminate the liquid accumulation and the like.

The internal flow path 111 of the nine-way valve 100 connects the outer section 122 and the outer section 124. The internal flow path 112 connects the outer section 123 and the outer section 125. The internal flow path 113 connects the outer section 121 and the outer section 127. The internal flow path 114 connects the outer section 120 and the outer section 126.

In the five-way valve 200, the opening 210 overlaps the lower compartment that communicates with each of the ports P1 and P2. Thus, the port P5 is in communication with the ports P1 and P2 of the ports P1 of P4.

Thus, the heating medium circulates through the first circuitry of the five-way valve 200 (port P5)-water pump 310-water cooled condenser 640-HVH 320-heater core 330-five-way valve 200 (port P2).

The heating medium also circulates through the second circuit of the five-way valve 200 (port P5), water pump 310, water cooled condenser 640, HVH 320, HT radiator 340, and five-way valve 200 (port P1).

The heat medium of the second circuit is branched into the flow path 30 at the branch point 371. The heat medium branched into the flow path 30 circulates through a third circuit of LT radiator 410, reserve tank 420, water pump 430, SPU 440, PCU 450, oil cooler 460, outer section 120, internal flow path 114, outer section 126, chiller 610, outer section 125, internal flow path 112, outer section 123, water pump 520, battery 510, outer section 124, inner flow path 111, outer section 122, flow path 800, outer section 121, internal flow path 113, outer section 127, and LT radiator 410.

The heat medium of the third circuit is branched into the flow path 50 at the branch point 531, and flows into the high-temperature circuit 300 from the branch point 380.

In the third heat medium circuit 1c, the series circuit 31 is formed similarly to the second heat medium circuit 1b. In the third heat medium circuit 1c, the heat medium does not flow through each of the flow path 40 and the flow path 60. In the third heat medium circuit 1c, the heat medium does not flow through the flow path 490.

### ECU Control Flowchart

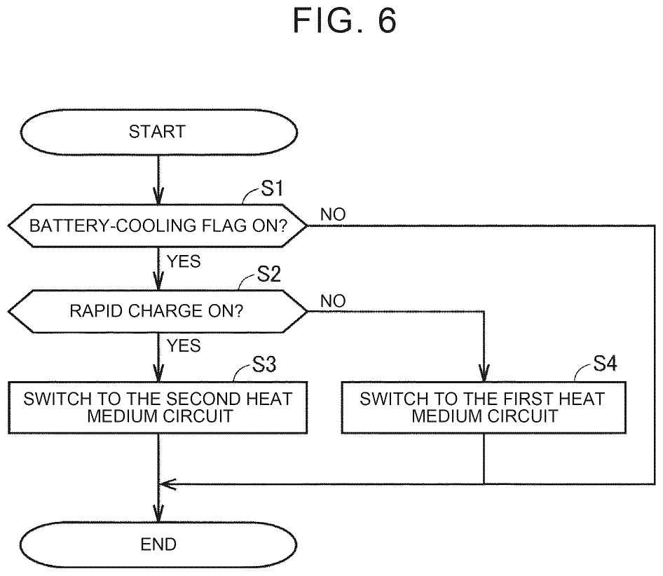

FIG. 6 is a diagram illustrating an exemplary control flow executed by ECU 2 (FIG. 1). The control flow illustrated in FIG. 6 may be executed (started) at a predetermined cycle (for example, every minute).

In S1, ECU 2 determines whether the battery-cooling flag is ON. The cell-cooling flag is turned ON when the detected value of the temperature sensor 540 that detects the temperature of the battery 510 is equal to or higher than a predetermined value (for example, 40° C.). If the cell-cooling flag is ON (Yes in S1), the process proceeds to S2. If the cell-cooling flag is OFF (No in S1), the process ends.

In S2, ECU 2 determines whether the charging method of the battery 510 is rapid charging (whether the rapid charging mode is ON). ECU 2 determines the charging method based on the information of the connector of electrified vehicle 20 to which the charging plug is connected, the information of the charging current, the information transmitted from the charging station, and the like. If the charging scheme is rapid charging (Yes in S2), the process proceeds to S3. If the charging scheme is not quick charging (normal charging) (No in S2), the process proceeds to S4.

In S3, ECU 2 controls the five-way valve 200 and the nine-way valve 100 to switch the thermal management circuit 1 to the second heat medium circuit 1b (FIG. 4). The battery 510 is then cooled by both HT radiator 340 and LT radiator 410. When the thermal management circuit 1 is switched to the second heat medium circuit 1b, the condition is maintained.

In S4, ECU 2 controls the five-way valve 200 and the nine-way valve 100 to switch the thermal management circuit 1 to the first heat medium circuit 1a (FIG. 3). Here, the battery 510 is cooled only by HT radiator 340 of HT radiator 340 and LT radiator 410. When the thermal management circuit 1 is switched to the first heat medium circuit 1a, the condition is maintained.

In addition, ECU 2 may control the five-way valve 200 and the nine-way valve 100 to switch the thermal management circuit 1 to the third heat medium circuit 1c (FIG. 5) while the cell-cooling flag is OFF.

As described above, in the present embodiment, ECU 2 controls the five-way valve 200 and the nine-way valve 100 to switch between the first heat medium circuit 1a and the second heat medium circuit 1b. In the first heat medium circuit 1a, HT radiator 340 and LT radiator 410 are separated from each other and are independent of each other.

The second heat medium circuit 1b includes a series circuit 31 in which HT radiator 340 and LT radiator 410 are connected in series. This makes it possible to easily switch between a mode in which the battery 510 is cooled by using two radiators (HT radiator 340 and LT radiator 410) and a mode in which the battery 510 is cooled by using only one radiator (HT radiator 340). Thus, by switching the two modes according to the temperature of the battery 510, the battery 510 can be cooled efficiently and with an appropriate cooling power.

In the above-described embodiment, an example in which a radiator for cooling the battery 510 is switchable has been described, but the present disclosure is not limited thereto. A radiator that cools a heat source other than the battery 510 (e.g., a PCU 450 or the like) may be switchable.

In the above embodiment, the thermal management circuit 1 is switched during external charging, but the present disclosure is not limited thereto. The thermal management circuit 1 may be switched at a time other than external charging. For example, the thermal management circuit 1 may be switched during high-load driving of the unit circuit 400 or the like. In this case, the switching control for connecting HT radiator 340 and LT radiator 410 in series may be performed only when the temperature of the heat medium of the unit circuit 400 is equal to or lower than a predetermined value (for example, 50° C.). As a result, it is possible to suppress the temperature of the unit circuit 400 becoming excessively high (for example, becoming 65° C. or higher).

In the above-described embodiment, the second heat medium circuit 1b is formed during external charging by rapid charging. For example, the second heat medium circuit 1b may be formed during external charging by normal charging.

In the above embodiment, the state of the thermal management circuit 1 is switched by controlling the nine-way valve 100 and the five-way valve 200, but the present disclosure is not limited thereto. The switching valve may have other configurations (e.g., a multi-way valve other than a five-way valve and a nine-way valve).

In the above embodiment, PCU 450 and the oil cooler 460 (transaxle 470) are connected in series, but the present disclosure is not limited thereto. PCU 450 and the oil cooler 460 (transaxle 470) may be connected in parallel.

Note that the configurations (processes) of the above-described embodiments and the above-described modification examples may be combined with each other.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A thermal management system in which a heat medium circulates, the thermal management system comprising:
a first radiator;
a second radiator that is different from the first radiator;
a switching device that switches a flow path of the heat medium; and
a control device that controls the switching device, wherein
the control device controls the switching device so as to switch between
a first heat medium circuit in which the first radiator and the second radiator are separated to be independent of each other, and
a second heat medium circuit that includes a series circuit in which the first radiator and the second radiator are connected in series with each other.

2. The thermal management system according to claim 1, further comprising:
a power storage device; and
a drive device capable of generating a drive force, wherein
in the first heat medium circuit,
the first radiator discharges heat supplied from the power storage device to outside air;
the heat medium flowing through the second radiator performs heat exchange with the drive device, and
in the second heat medium circuit, each of the first radiator and the second radiator discharges the heat supplied from the power storage device to the outside air.

3. The thermal management system according to claim 2, wherein the control device forms the second heat medium circuit by controlling the switching device when the power storage device is externally charged.

4. The thermal management system according to claim 3, wherein the control device forms the second heat medium circuit by controlling the switching device when the power storage device is externally charged through rapid charging.

5. The thermal management system according to claim 1, wherein:
the switching device includes a nine-way valve and a five-way valve; and
the control device switches between the first heat medium circuit and the second heat medium circuit by controlling each of the nine-way valve and the five-way valve.
